(19) United States
(12) Patent Application Publication
(10) Pub. No.: US 2026/0034900 A1
(43) Pub. Date: Feb. 5, 2026

(54) CONTROLLING CURRENT FOR DIRECT CURRENT FAST CHARGE WITH HEAT GENERATION AND TEMPERATURE CONTROL

(71) Applicant: GM GLOBAL TECHNOLOGY OPERATIONS LLC, DETROIT, MI (US)

(72) Inventors: Rafid Shariful Mollah, Troy, MI (US); Yangbing Zeng, Troy, MI (US); Han Zhang, Shelby Township, MI (US); Taylor Reed Garrick, Bloomfield Hills, MI (US); Brian J. Koch, Berkley, MI (US)

(21) Appl. No.: 18/792,642

(22) Filed: Aug. 2, 2024

(51) Int. Cl. B60L 53/10; B60L 58/27; H01M 10/0525; H01M 10/44; H01M 10/46; H02J 7/00

(52) U.S. Cl. CPC B60L 53/11; B60L 58/27; H01M 10/0525; H01M 10/44; H01M 10/46; H02J 7/00712; H01M 2220/20

(57) ABSTRACT

Examples described herein provide a method for direct current (DC) fast charging for a cell of a battery of a vehicle. The method includes determining an anode potential current to apply during the DC fast charging. The method further includes determining a heat generation current to apply during the DC fast charging. The method further includes determining a cell voltage current to apply during the DC fast charging. The method further includes selecting a minimum current from the anode potential current, the heat generation current, and the cell voltage current. The method further includes charging the cell of the battery of the vehicle based on the minimum current.

### BACKGROUND

The subject disclosure relates to vehicles, and in particular to controlling current for direct current fast charge (DCFC) with heat generation and temperature control.

Modern vehicles (e.g., a car, a motorcycle, a boat, or any other type of automobile) may be equipped with one or more batteries, battery packs, and/or battery systems to provide electrical power to components or systems within such vehicles. Some vehicles include an internal combustion engine fueled by gasoline, diesel, or the like. Other vehicles, like hybrid electric vehicles and electric vehicles, are partially or wholly powered by electrical power.

### SUMMARY

In one embodiment, a method for direct current (DC) fast charging for a cell of a battery of a vehicle under is provided. The method includes determining an anode potential current to apply during the DC fast charging. The method further includes determining a heat generation current to apply during the DC fast charging. The method further includes determining a cell voltage current to apply during the DC fast charging. The method further includes selecting a minimum current from the anode potential current, the heat generation current, and the cell voltage current. The method further includes charging the cell of the battery of the vehicle based on the minimum current.

In addition to one or more of the features described herein, or as an alternative, further embodiments of the method may include that the anode potential current is determined using an anode potential proportional-integral-derivative controller.

In addition to one or more of the features described herein, or as an alternative, further embodiments of the method may include that the heat generation current is determined using a heat generation proportional-integral-derivative controller.

In addition to one or more of the features described herein, or as an alternative, further embodiments of the method may include that the cell voltage current is determined using a cell voltage proportional-integral-derivative controller.

In addition to one or more of the features described herein, or as an alternative, further embodiments of the method may include that the anode potential current, the heat generation current, and the cell voltage current are based at least in part on a lithium battery (LiB) value for a present time t₀, a cell temperature for the present time t₀, a state of charge for the present time t₀, and a current for the present time t₀.

In addition to one or more of the features described herein, or as an alternative, further embodiments of the method may include performing a simulation of fast charging the cell of the battery of the vehicle using the minimum current.

In addition to one or more of the features described herein, or as an alternative, further embodiments of the method may include charging the cell of the battery of the vehicle based on results of performing the simulation of fast charging the cell of the battery of the vehicle using the minimum current.

In addition to one or more of the features described herein, or as an alternative, further embodiments of the method may include that the simulation of fast charging the cell of the battery of the vehicle includes projecting cell response to the minimum current for a forward-looking period of time.

In addition to one or more of the features described herein, or as an alternative, further embodiments of the method may include that determining the heat generation current is based on a cell heat generation rate for the cell of the battery and a cell heat rejection rate of the cell of the battery.

In addition to one or more of the features described herein, or as an alternative, further embodiments of the method may include iteratively repeating determining the anode potential current, determining the heat generation current, determining the cell voltage current, selecting the minimum current, and charging the cell of the battery of the vehicle iteratively based on a change in time.

In another embodiment, a vehicle is provided. The vehicle includes a battery having a cell and a proportional-integral derivative-based (PID) controller. The PID controller includes a memory having computer readable instructions. The PID controller further includes a processing device for executing the computer readable instructions, the computer readable instructions controlling the processing device to perform operations for current (DC) fast charging for the cell of the battery of the vehicle under non-uniform temperature distribution. The operations include determining an anode potential current to apply during the DC fast charging. The operations further include determining a heat generation current to apply during the DC fast charging. The operations further include determining a cell voltage current to apply during the DC fast charging. The operations further include selecting a minimum current from the anode potential current, the heat generation current, and the cell voltage current. The operations further include charging the cell of the battery of the vehicle based on the minimum current.

In addition to one or more of the features described herein, or as an alternative, further embodiments of the vehicle may include that the anode potential current is determined using an anode potential proportional-integral-derivative controller.

In addition to one or more of the features described herein, or as an alternative, further embodiments of the vehicle may include that the heat generation current is determined using a heat generation proportional-integral-derivative controller.

In addition to one or more of the features described herein, or as an alternative, further embodiments of the vehicle may include that the cell voltage current is determined using a cell voltage proportional-integral-derivative controller.

In addition to one or more of the features described herein, or as an alternative, further embodiments of the vehicle may include that the anode potential current, the heat generation current, and the cell voltage current are based at least in part on a lithium battery (LiB) value for a present time t₀, a cell temperature for the present time t₀, a state of charge for the present time t₀, and a current for the present time t₀.

In addition to one or more of the features described herein, or as an alternative, further embodiments of the vehicle may include that the operations further include performing a simulation of fast charging the cell of the battery of the vehicle using the minimum current.

In addition to one or more of the features described herein, or as an alternative, further embodiments of the vehicle may include that the operations further include charging the cell of the battery of the vehicle based on results of performing the simulation of fast charging the cell of the battery of the vehicle using the minimum current.

In addition to one or more of the features described herein, or as an alternative, further embodiments of the vehicle may include that the simulation of fast charging the cell of the battery of the vehicle includes projecting cell response to the minimum current for a forward-looking period of time.

In addition to one or more of the features described herein, or as an alternative, further embodiments of the vehicle may include that determining the heat generation current is based on a cell heat generation rate for the cell of the battery and a cell heat rejection rate of the cell of the battery.

In another embodiment a computer program product is provided. The computer program product includes a computer readable storage medium having program instructions embodied therewith, the program instructions executable by at least one processor to cause the at least one processor to perform operations for direct current (DC) fast charging for a cell of a battery of a vehicle under non-uniform temperature distribution. The operations include determining an anode potential current to apply during the DC fast charging. The operations further include determining a heat generation current to apply during the DC fast charging. The operations further include determining a cell voltage current to apply during the DC fast charging. The operations further include selecting a minimum current from the anode potential current, the heat generation current, and the cell voltage current. The operations further include charging the cell of the battery of the vehicle based on the minimum current.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically illustrates an electrified drivetrain for a vehicle including a rechargeable energy storage system and charging system, according to one or more embodiments;

FIG. 2 schematically illustrates a battery module for a rechargeable energy storage system, according to one or more embodiments:

FIG. 3 schematically illustrates a cutaway side view of a single battery cell, according to one or more embodiments:

FIG. 4 schematically illustrates a cutaway side view of a single battery cell including non-uniform temperature distribution and spatial-dependent temperature transition zones along the cell length direction, according to one or more embodiments:

FIG. 5 schematically illustrates graphs for cell temperature limits, according to one or more embodiments.

FIG. 6 schematically illustrates a method for simulating a DC fast charge calibration curve under non-uniform temperature distribution in a battery cell, according to one or more embodiments:

FIGS. 7A and 7B schematically illustrate graphs of applied current, according to one or more embodiments; and

FIG. 8 schematically illustrates a block diagram of a processing system for implementing one or more embodiments described herein.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to modeling direct current fast charge (DCFC) with heat generation and temperature control.

Direct current (DC) power sources, such as batteries, are electrochemical devices that may be employed to store and release electric power that may be employed by an electric circuit or an electric machine to perform work, such as for communications, display, or propulsion. Heat may be generated by the processes of converting electric power to chemical potential energy (e.g., battery charging), and converting chemical potential energy to electric power (e.g., battery discharging).

A lithium battery is a rechargeable electrochemical device that operates by reversibly passing lithium ions between a negative electrode (or anode) and a positive electrode (or cathode). The negative and positive electrodes are situated on opposite sides of a porous polymer separator that is soaked with an electrolyte solution suitable for conducting lithium ions. Each of the negative and positive electrodes is also accompanied by a respective current collector. The current collectors of the two electrodes are connected by an interruptible external circuit that allows an electric current to pass between the electrodes to electrically balance migration of lithium ions. Further, the negative electrode may include a lithium intercalation host material, and the positive electrode may include a lithium-based active material that can store lithium ions at a higher electrochemical potential than the intercalation host material of the negative electrode.

Charging of a lithium battery includes supplying electric power across the positive and negative electrodes to effect migration of lithium ions. Charging of a lithium battery may induce heat generation. Heat generation may be non-uniform between cells of a lithium battery, and non-uniform within an individual cell of a lithium battery. When a temperature of a portion of a cell drops below a threshold temperature, lithium plating may occur, wherein lithium is deposited onto a surface of an anode more rapidly than intercalation may occur. Lithium plating may reduce a charge capacity of the cell and thus reduce charge capacity of the battery and shorten its service life. Thus, charging the lithium battery outside of a threshold temperature may accelerate aging of the battery, reduce the service life of the battery, and/or reduce the energy storage capacity thereof.

A lithium battery may be more susceptible to lithium plating during charging at higher charging voltages, such as may be present during fast charging events, which may be used when charging electric vehicles, hybrid electric vehicles, and/or the like, including combinations and/or multiples thereof.

There is a need to rapidly charge a lithium battery while avoiding conditions that may cause lithium plating, which may otherwise accelerate aging of the battery, reduce the service life of the battery, and/or reduce the energy storage capacity thereof. Rapidly charging a lithium battery may include charging the lithium battery at an elevated voltage level in a manner that eliminates or minimizes temperature excursions above a threshold temperature to avoid or minimize lithium plating. There is a need to dynamically and accurately control one or more parameters related to charging a battery cell, or a battery cell pack containing multiple battery cells to mitigate effects of excess temperature on aging, service life, and/or energy storage capacity.

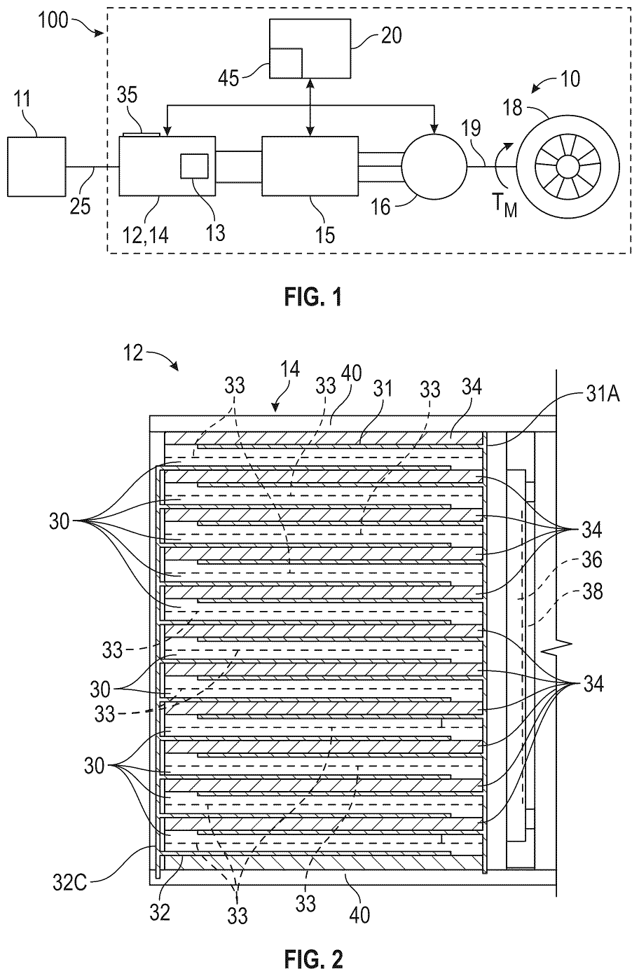

FIGS. 1 and 2 schematically illustrate elements related to a vehicle 100 including an electrified drivetrain 10 and a rechargeable energy storage system (RESS) 12, which is couplable via power cord and connector 25 to an electric power supply 11 via a charger 13. The vehicle 100 may include, but is not limited to, a mobile platform in the form of a commercial vehicle, industrial vehicle, agricultural vehicle, passenger vehicle, aircraft, watercraft, train, all-terrain vehicle, personal movement apparatus, robot, and the like to accomplish the purposes of this disclosure. One or more embodiments described herein may be applied in environments or devices other than vehicles, such as power tools, virtual reality headsets, smartphones, and/or the like, including combinations and/or multiples thereof.

The electric power supply 11 is coupled to an electric power source originating from a public or a private electric power supplier and is arranged to channel electric power via the power cord and connector 25 to the RESS 12 via the charger 13 when the vehicle 100 is stationary. The electric power may be delivered at nominal voltage levels of 120 VAC, 240 VAC, 360 VAC, 480 VAC, or another voltage level without limitation. The power cord and connector 25 may be an Electric Vehicle Supply Equipment (EVSE) device, or another device, without limitation.

The electrified drivetrain 10 may be an electric drivetrain that employs only electrical devices to generate tractive power, such as electric motor/generators. Alternatively, the electrified drivetrain 10 may be a hybrid electric drivetrain that employs multiple devices to generate electric power and/or tractive torque, such as an internal combustion engine or a fuel cell, for example.

As illustrated, the electrified drivetrain 10 includes the RESS 12, a power inverter 15, an electric machine 16, and a drive wheel 18. The RESS 12 is electrically coupled to and provides electrical energy (VDC) to one or more power sources, such as the electric machine 16, via the power inverter 15. The electric machine 16 provides tractive torque (TM) 19 to the drive wheel 18.

The RESS 12 includes one or a plurality of battery cell module assemblies (BCMA) 14, one of which is illustrated with reference to FIG. 2.

The RESS 12 is connected to the charger 13, which includes a charging inlet port into which the connector 25 may be plugged for purposes of charging the RESS 12 when the vehicle 100 is stationary. The charger 13 is an electric device that is controllable by a DC current fast charge (DCFC) control routine 45 that is executed by a controller 20 to manage electric power flow to the RESS 12.

The controller 20 is arranged to monitor the RESS 12, the power inverter 15, and the electric machine 16.

The controller 20 also includes a non-transitory digital data storage medium on which a control routine 45 is stored in one or multiple encoded datafiles that are executable by a processor of the controller 20. An embodiment of the control routine 45 is described with reference to FIG. 2.

The controller 20 may also include control routines for monitoring and controlling operations of the power inverter 15 and the electric machine 16.

One or multiple heat exchangers 35 are in thermal contact with the RESS 12 and/or the inverter 15 to effect heat transfer. The heat exchangers 35 may be heat pump devices in one embodiment, such as a thermoelectric device that operates in accordance with the Peltier effect. Alternatively, the heat exchangers 35 may be an air-air heat exchanger employing a controllable fan, a dedicated coolant loop, etc.

FIG. 2 is a plan view of one of the BCMAs 14 included in the RESS 12 of FIG. 1. The BCMA 14 includes a plurality of battery cells 30. Each of the battery cells 30 includes an anode and anode current collector that are designated collectively as element 31, and a cathode and cathode current collector that are designated collectively as element 32. A single one of the anode and anode current collector 31 is designated, and a single one of the cathode and cathode current collector 32 is designated. The battery cells 30 may be connected in series, in parallel, or a combination thereof, via an anode interconnect board 31A and a cathode interconnect board 32C. Adjacent battery cells 30 may be stacked against one another, or may be separated by gaps or by foam 34, for example.

The BCMA 14 includes a cell monitoring unit 36 that has a printed circuit board 38 (represented in phantom) configured to monitor one or more parameters of the battery cells 30. The anode and cathode interconnect boards 31A, 32C may be disposed between the plurality of battery cells 30 and the cell monitoring unit 36 and includes electronic components that physically connect the plurality of battery cells 30 with the cell monitoring unit 36 and the printed circuit board 38 thereon. Container 40 may enclose the battery cells 30 of the BCMA 14.

In one embodiment, each of the battery cells 30 is a rechargeable lithium-metal or lithium-ion (lithium) battery cell. A lithium battery generally operates by reversibly passing lithium ions between a negative electrode (or anode) and a positive electrode (or cathode). The negative and positive electrodes are situated on opposite sides of a porous polymer separator that is soaked with an electrolyte solution suitable for conducting lithium ions. Each of the negative and positive electrodes is also accommodated by a respective current collector. The current collectors associated with the two electrodes are connected by an interruptible external circuit that allows an electric current to pass between the electrodes to electrically balance the related migration of lithium ions. Further, the negative electrode may include a lithium intercalation host material, and the positive electrode may include a lithium-based active material that can store lithium ions at a higher electric potential than the intercalation host material of the negative electrode.

During a discharge process, lithium active particles diffuse up to a surface of the anode where they react, producing lithium ions that flow through an electrolyte solution via diffusion and migration until they arrive at the cathode. The positively charged ions react with the metal oxide material particles of the cathode and diffuse within it. The electrons produced in the anode reaction cannot flow through the electrolyte solution that acts as insulator and flow through an external circuit, producing electrical current. The inverse reactions occur during a charge process. Battery cell parameters include voltage, current, temperature, etc.

In one embodiment, the battery cells 30 are configured as rectangular prismatic devices, and each battery cell is configured as a pouch-type element. Alternatively, the battery cells may be configured as cylindrical devices.

The controller 20 is arranged to monitor the RESS 12 and includes communication links to the anode collector 31 and the cathode collector 32 for monitoring parameters of the battery cells 30 of the RESS 12, communication links to the inverter 15, and communication links to the electric machine 16.

The controller 20 also includes a non-transitory digital data storage medium on which a control routine 45 is stored in one or multiple encoded datafiles that are executable by a processor of the controller 20.

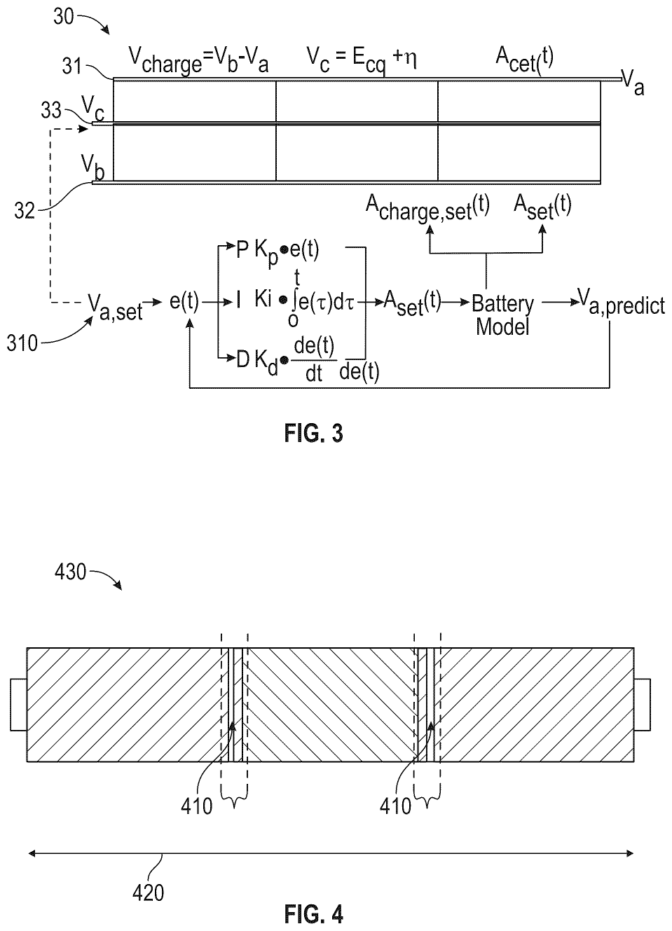

FIG. 3 schematically illustrates a cutaway sideview of one of the battery cells 30, including the anode and anode collector 31, the cathode and cathode collector 32, and separator 33. An exemplary proportional-integral-derivative (PID) control equation 310 is also illustrated.

Electric potential at the anode collector 31 is designated Vₐ, electric potential at the cathode collector 32 is designated V_{b}, and electric potential at the separator 33 is designated V_{c}. The electric potential (V_{charge}) of the battery cell is as follows:

$${V}_{charge} = {V}_{b} - {V}_{a}$$

The PID controller 310 determines e(t) from the contribution between the subtraction of the anode solid phase potential Vₐ and the anode potential offset setpoint V_{a,set}. The anode potential offset represents a difference between a local anode solid phase potential and a potential at which lithium plating spontaneously occurs, which is known or knowable. Based on the calculation of the PID controller 310, the instant PID controller fast charge current A_{charge,set}(t) may be derived. By comparing the PID controller fast charge current A_{charge,set}(t) and the input current Aₛₑₜ(t) in the battery model, the smaller current is used to predict the anode potential V_{a,predict}. The predicted anode potential V_{a,predict} is returned to the PID controller 310 for the next round fast charge current A_{charge,set}(t) calculation until it reaches the anode potential offset V_{a,set}.

FIG. 4 schematically illustrates a cutaway side view of an embodiment of a single battery cell 430 including a non-uniform temperature distribution and spatial-dependent temperature transition zones 410 along the cell length direction 420. A non-uniform temperature distribution in the 3D porous electrode model is generated by adding the spatial-dependent temperature transition zones along the cell length direction.

In certain scenarios, it may be desirable to reduce or limit a cell heat generation rate (e.g., the rate at which the cell generates heat) such that the cell heat generation rate does not exceed a cell heat rejection rate. The cell heat rejection rate is the Watts in a given cell volume being estimated by a chemical or electrochemical model of the battery cell. More particularly, by controlling DC fast charging of a cell based on cell voltage, anode potential, and cell temperature, a best charging current can be determined to change the battery cell, thus improving the performance and extending the lifespan of the cell.

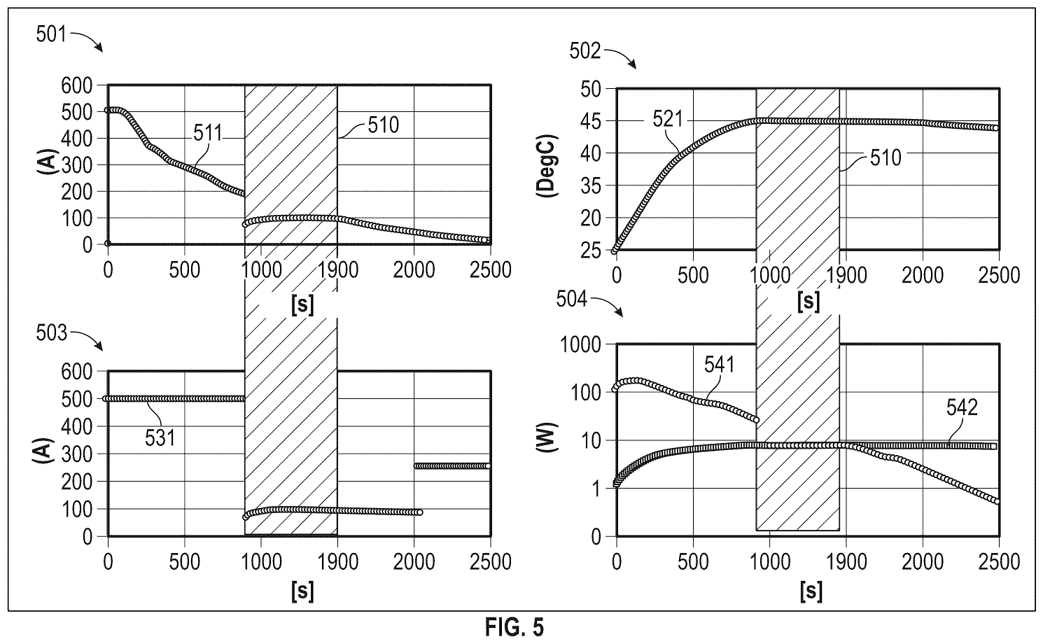

One or more embodiments described herein combines a three-dimensional (3D) porous electrode electrochemical model with a software defined controller (e.g., the controller 20) and three-electrode lithium plating criteria to predict or control a DC fast charge calibration curve under non-uniform temperature distribution in a battery cell (e.g., one of the battery cells 30). For example, FIG. 5 depicts DC fast charge calibration curve 511 in graph 501, which relates to cell temperature limit. The graph 501 plots a minimum charging current (in amps (A)) over time (in seconds(s)). As can be seen, the minimum charging current decreases over time.

One or more embodiments described herein implements a software controller approach, using the controller 20, to a 3D non-uniform temperature distribution level to predict the DC fast charge calibration curve while avoiding lithium plating at the anode of a lithium-ion battery cell. For example, with reference to FIG. 5, the graph 502, which relates to cell temperature limit, plots cell temperature (in degrees Celsius (C)) during DC fast charging over time (in seconds(s)) as shown by the curve 521.

Cell temperature current control, as shown in the graph 503, can be used to reduce heat generation and rejection (see graph 504). For example, the graph 503, which relates to cell temperature control current, plots current (in amps (A)) over time (in seconds(s)), as shown by the curve 531. The graph 504, which relates to heat generation and rejection during DC fast charging, plots heat generation (in watts (W)) over time (in seconds(s)), as shown by the curve 541.

One or more embodiments described herein implements a software controller approach, using the controller 20, to a 3D non-uniform temperature distribution level to predict the DC fast charge calibration curve (e.g., the curve 511) while avoiding lithium plating at the anode of a lithium-ion battery cell. One or more embodiments uses a coolant heat rejection rate, shown as the curve 542 of the graph 504 of FIG. 5, to determine the minimum current that can be put into the cell to maintain substantially constant temperature charging once the cell maximum temperature is reached. For example, as shown in the graphs 501-504, the region 510 represents a time period in which a minimum current is put into the cell to maintain constant temperature charging (see graph 502, which shows temperature level off once the time period for the region 510 begins). That is, the region 510 represents a period of time in which thermal control is enabled. By controlling the current in this way, the cell heat generation rate (e.g., the rate at which the cell generates heat (see graph 504)) does not exceed a cell heat rejection rate. The minimum current is determined in a similar manner as the lithium-plating approach.

One or more embodiments described herein provide for building a representative 3D porous electrode model considering the partial differential equations that govern the chemical transport, chemical reactions, voltage, and current distribution in the cell. The 3D porous electrode model is used to define the non-uniform temperature distribution of the battery cell by adding spatial-dependent temperature transition zones along the cell length direction (see FIG. 3), determine the non-uniform heat generation in the battery cell, and calculate the temperature distribution in time as the DC fast charge event progresses. This provides for the fast charge event to fully capture the benefit of increased temperature and the nuances of a particular cooling system implementation.

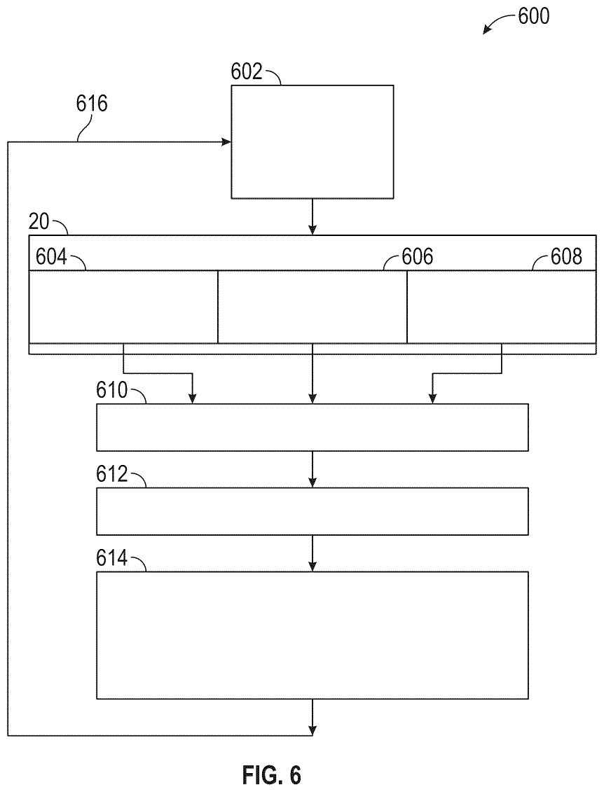

One or more embodiments described herein provide a software defined controller (e.g., the anode potential PID controller 604 as shown in FIG. 6) of a proportional integral derivative (PID) type to control the cell level voltage and applied current in order to meet a control setpoint. The control setpoint can be defined as an anode potential offset, analogous to a three-electrode potential offset.

One or more embodiments described herein apply a maximum charging current to the battery cell, monitor the cell voltage, and simulate/predict the anode potential at the interface between anode and separator. The PID-based controller (e.g., the controller 20 as shown in FIG. 6) can be used to modify the cell voltage and charging current to follow the anode potential setpoint, ensuring that the impact of the non-uniform temperature on the local minimum anode potential is captured. Simulating/predicting the anode potential can be performed at time steps (e.g., Δt). At each time step, the anode active material solid phase concentration is evaluated to ensure that it does not approach lithium plating criteria.

One or more embodiments described herein define a software defined controller (e.g., the heat generation PID controller 606 as shown in FIG. 6) of a PID type to control the cell heat generation rate, and apply a current in order to meet a control setpoint. According to one or more embodiments, the control setpoint is defined as the cell heat rejection rate that activates once the cell maximum allowable temperature is reached. According to one or more embodiments, the predicted cell maximum allowable temperature is based on an average cell stack temperature, a local maximum temperature, and/or the like, including combinations and/or multiples thereof. In one or more embodiments where a cell thermocouple is available, a measured temperature of the battery cell can be used as an input to the heat generation PID controller 606.

According to one or more embodiments, the maximum charging current is applied to the battery cell. The cell stack maximum temperature is then predicted for the feedforward prediction of what the fast charge profile would look like given the current vehicle status, and if the cell stack maximum temperature or cell thermocouple reading is greater than the cell maximum allowable temperature, the heat generation PID controller 606 is used to modify the charging current such that the cell heat generation rate is at most the cell heat rejection rate.

According to one or more embodiments, the minimum current is applied such that cell terminal voltage, lithium-plating, and cell thermal limits are not violated.

Turning now FIG. 6, a schematic illustration of a method 600 for simulating a DC fast charge calibration curve under non-uniform temperature distribution in a battery cell, according to an embodiment. The method 600 provides for virtually determining the state of a battery cell (e.g., one of the battery cells 30) and the ability to interface with one or more PID controllers that control cell voltage, anode potential, and cell temperature to set a simulation current that can be used to charge cells. The routine 45 is a model-based approach that applies a thermistor value to a model and controls to the anode potential rather than taking the temperature and performing a table-based lookup. However, in some embodiments, a table-based lookup can be implemented, using, for example, lithium-plating look up tables. By using the model-based approach shown in the routine 45, an optimum charging current can be determined for charging the cell. The routine 45 provides for optimal charging of battery cells while minimizing battery damage, thus improving the functioning of the battery cells.

In FIG. 6, the method 600 starts at block 602, where values for a lithium battery (LiB), a cell temperature (Cell Temp), state of charge (SOC), and current (i) for a present time t₀ are determined. The lithium battery value defines properties of the battery chemistry for the battery cell. The cell temperature is a current cell temperature of the battery cell, which is determined by modeling or sensing/measuring. The state of charge is a measure of the amount of energy remaining in the battery cell relative to a total capacity of the battery cell. The state of charge is determined by sensing/measuring. According to one or more embodiments, the state of charge can be confirmed by estimating a rest voltage at any given state. The current is the charging current being supplied to the battery cell during DC fast charging as measured. The current is measured by the controller as the battery is being charged, while at the same time the feed-forward current is modeled in real time (or near real time) to optimize the charging profile.

The values from block 602 are fed into the controller 20, which may be a PID controller and may be implemented using any suitable hardware and/or software, such as a microcontroller, digital signal processor, and/or the like, including combinations and/or multiples thereof. The controller 20 models aspects of the battery cell, such as anode potential, heat generation, and cell voltage and predicts what the cell temperature would be to control the current. Instead of directly controlling temperature, a measure of heat that is rejected is used to control or predict the cell temperature. For example, the controller 20 uses one or more PIDs to modify the charging current for the battery cell such that the cell heat generation rate (e.g., the rate at which the cell generates heat) does not exceed a cell heat rejection rate.

In the example of FIG. 6, the controller 20 may include multiple sub-controllers, which may also be PID controllers or other suitable control techniques. For example, the controller 20 includes an anode potential PID controller 604, a heat generation PID controller 606, and a cell voltage PID controller 608 (collectively referred to as sub-controllers 604-608). Each of the sub-controllers 604-608 generates a current I₁, I₂, I₃ respectively for charging the battery cell. More particularly, the anode potential PID controller 604 generates the current I₁ (also referred to as an anode potential current), the heat generation PID controller 606 generates the current I₂ (also referred to as a heat generation current), and the cell voltage PID controller 608 generates the current I₃ (also referred to as a cell voltage current). Each of the currents I₁, I₂, I₃ acts as a limit on the amount of current for charging the battery cell based on anode potential, heat generation, and cell voltage, respectively. That is, the current I₁ from the anode potential PID controller 604 is a current limit that prevents the anode potential from being exceeded, as described with respect to FIG. 3, for example. The currents I₂ and I₃ similarly act as limits on the heat generation for the battery cell and on the cell voltage for the battery cell, respectively.

Each of the currents I₁, I₂, I₃ from the respective sub-controllers 604-608 is fed into block 610, where it is determined which of the currents I₁, I₂, I₃ is a minimum current. The minimum current is the lowest value of the currents I₁, I₂, I₃. By determining which current I₁, I₂, I₃ is the minimum current, the controller 20 can control charging current for the battery cell in consideration of anode potential, heat generation, and cell voltage. That is, by using the minimum current, the controller 20 can limit the charging current to prevent each of the anode potential, the heat generation, and the cell voltage from being exceeded. According to one or more embodiments, the optimal charge profile may be one where the maximum allowed temperature is seen to occur at the moment that charging completes. This captures the tradeoff in resistance decreasing with temperature increase. It should be appreciated that heat generation decreases as resistance decreases.

At block 612, the minimum current from block 610 is used to charge the cell and/or to perform a simulation of charging the cell. For example, the minimum current is used for real-time control of the current applied to the cell during DC fast charging. In another example, the minimum current is set as a simulation current, which is the current used to simulate DC fast charging of the battery cell. Simulating DC fast charging involves projecting ahead in time how the cell will respond to different currents being applied. For example, the method 600 could be run periodically (e.g., every 10-30 seconds) to project/simulate what changing will look like for a forward-looking period of time (e.g., the next 30 minutes). This feed-forward based approach provides for adjusting values (e.g., the lithium battery (LiB), the cell temperature (Cell Temp), the state of charge (SOC), the current (i), and/or the like, including combinations and/or multiples thereof) preemptively.

At block 614, a change in time (Δt) is then applied to each of the values (e.g., cell temperature (Cell Temp), state of charge (SOC), and current (i)) from block 602 to advance from the time t₀ to a next time (t₀+Δt). The simulation advances to a new state 616, which is the change of time (Δt) ahead of the present time. In this way, the method 600 can iteratively repeat, such as every change of time (Δt). For example, if the change of time is 10 seconds, the method 600 can repeat every 10 seconds, although other periods can be used as well (e.g., 5 seconds, 30 seconds, 60 seconds, 90 seconds, and/or the like, including combinations and/or multiples thereof). According to one or more embodiments, the method 600 can repeat on an a periodic basis, can end after a predetermined period of time or number of iterations, can be performed responsive to a trigger event (e.g., the start of DC fast charging), response to a user command, and/or the like, including combinations and/or multiples thereof.

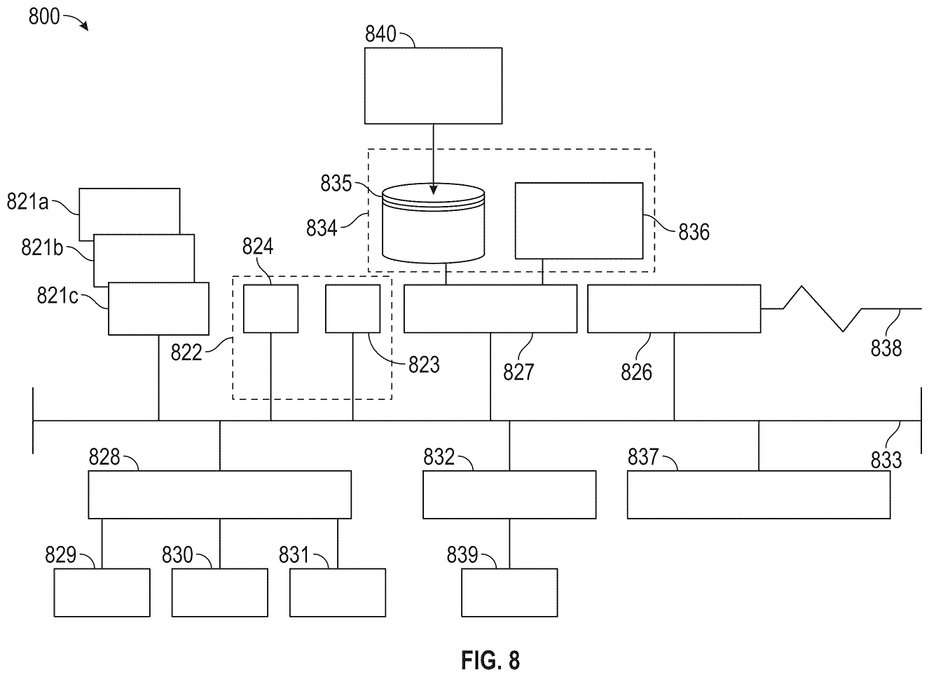

Additional processes also may be included, and it should be understood that the processes depicted in FIG. 6 represent illustrations, and that other processes may be added, or existing processes may be removed, modified, or rearranged without departing from the scope of the present disclosure. It should also be understood that the processes depicted in FIG. 6 may be implemented as programmatic instructions stored on a non-transitory computer-readable storage medium that, when executed by a processor (e.g., the processing device 202 of FIG. 2, the processor(s) 821 of FIG. 8, and/or the like, including combinations and/or multiples thereof) of a computing system (e.g., the processing system 102 of FIGS. 1 and 2, the processing system 800 of FIG. 8, and/or the like, including combinations and/or multiples thereof), cause the processor to perform the processes described herein.

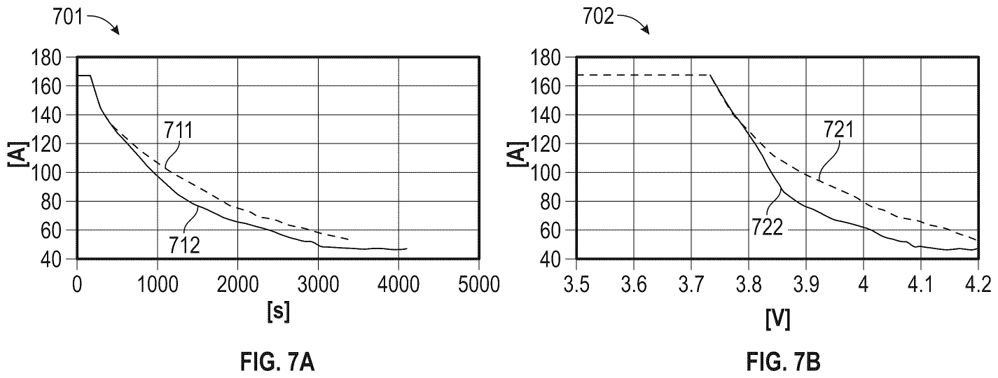

FIGS. 7A and 7B schematically illustrate graphs 701, 702 of applied current according to one or more embodiments. Particularly, the graph 701 illustrates current (in amps (A)) over time (in seconds(s)) for both uniform temperature (curve 711) and non-uniform temperature (curve 712). The graph 702 illustrates the current (in amps (A)) plotted against terminal voltage (in volts (V)) for uniform temperature (curve 721) and non-uniform temperature (curve 722). From the graphs 701, 702, it is evident that one or more embodiments described herein provides for optimal charging of cells while minimizing battery damage. This is accomplished by using a model-based approach that can virtually determine the state of a cell, and the ability of the model to interface with PID controllers that control cell voltage, anode potential, and cell temperature the best charging current in real-time can be determined to charge cells.

As used herein, “anode potential current” can also be referred to or known as “anode potential limited current” or “anode potential limiting current.” Similarly, “heat generation current” can also be referred to or known as “heat generation limited current” or “heat generation limiting current.” “Cell voltage current” can also be referred to or known as “cell voltage limited current” or “cell voltage limiting current.”

It is understood that one or more embodiments described herein is capable of being implemented in conjunction with any other type of computing environment now known or later developed. For example, FIG. 8 depicts a block diagram of a processing system 800 for implementing the techniques described herein. In accordance with one or more embodiments described herein, the processing system 800 is an example of a cloud computing node of a cloud computing environment. In examples, processing system 800 has one or more central processing units (referred to also as “processors” or “processing resources” or “processing devices”) 821a, 821b, 821c, etc. (collectively or generically referred to as processor(s) 821 and/or as processing device(s)). In aspects of the present disclosure, each processor 821 can include a reduced instruction set computer (RISC) microprocessor. Processors 821 are coupled to a system memory 822 and/or various other components via a system bus 833. The system memory 822 can include one or more temporary and/or persistent memory devices, such as a random access memory (RAM) 823, a read-only memory (ROM) 824, and/or the like, including combinations and/or multiples thereof. The system bus 833 may include a basic input/output system (BIOS), which controls certain basic functions of processing system 800.

Further depicted are an input/output (I/O) adapter 827 and a network adapter 826 coupled to system bus 833. I/O adapter 827 may be a small computer system interface (SCSI) adapter that communicates with a hard disk 835 and/or a storage device 836 or any other similar component. I/O adapter 827, hard disk 835, and storage device 836 are collectively referred to herein as mass storage 834. Operating system 840 for execution on processing system 800 may be stored in mass storage 834. The network adapter 826 interconnects system bus 833 with an outside network 838 enabling processing system 800 to communicate with other such systems.

A display (e.g., a display monitor) 839 is connected to system bus 833 by display adapter 832, which may include a graphics adapter to improve the performance of graphics intensive applications and a video controller. In one aspect of the present disclosure, adapters 826, 827, and/or 832 may be connected to one or more I/O buses that are connected to system bus 833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 833 via user interface adapter 828 and display adapter 832. A keyboard 829, mouse 830, and speaker 831 may be interconnected to system bus 833 via user interface adapter 828, which may include, for example, a Super I/O chip integrating multiple device adapters into a single integrated circuit.

In some aspects of the present disclosure, processing system 800 includes a graphics processing unit (GPU) 837. Graphics processing unit 837 is a specialized electronic circuit designed to manipulate and alter memory to accelerate the creation of images in a frame buffer intended for output to a display. In general, graphics processing unit 837 is very efficient at manipulating computer graphics and image processing, and has a highly parallel structure that makes it more effective than general-purpose CPUs for algorithms where processing of large blocks of data is done in parallel.

Thus, as configured herein, processing system 800 includes processing capability in the form of processors 821, storage capability including the system memory 822 and mass storage 834, input means such as keyboard 829 and mouse 830, and output capability including speaker 831 and display 839. In some aspects of the present disclosure, a portion of system memory 822 and mass storage 834 collectively store the operating system 840 to coordinate the functions of the various components shown in processing system 800.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for direct current (DC) fast charging for a cell of a battery of a vehicle, the method comprising:
determining an anode potential current to apply during the DC fast charging;
determining a heat generation current to apply during the DC fast charging;
determining a cell voltage current to apply during the DC fast charging;
selecting a minimum current from the anode potential current, the heat generation current, and the cell voltage current; and
charging the cell of the battery of the vehicle based on the minimum current.

2. The computer-implemented method of claim 1, wherein the anode potential current is determined using an anode potential proportional-integral-derivative controller.

3. The computer-implemented method of claim 1, wherein the heat generation current is determined using a heat generation proportional-integral-derivative controller.

4. The computer-implemented method of claim 1, wherein the cell voltage current is determined using a cell voltage proportional-integral-derivative controller.

5. The computer-implemented method of claim 1, wherein the anode potential current, the heat generation current, and the cell voltage current are based at least in part on a lithium battery (LiB) value for a present time t₀, a cell temperature for the present time t₀, a state of charge for the present time t₀, and a current for the present time t₀.

6. The computer-implemented method of claim 1, further comprising performing a simulation of fast charging the cell of the battery of the vehicle using the minimum current.

7. The computer-implemented method of claim 6, further comprising charging the cell of the battery of the vehicle based on results of performing the simulation of fast charging the cell of the battery of the vehicle using the minimum current.

8. The computer-implemented method of claim 6, wherein the simulation of fast charging the cell of the battery of the vehicle comprises projecting cell response to the minimum current for a forward-looking period of time.

9. The computer-implemented method of claim 1, wherein determining the heat generation current is based on a cell heat generation rate for the cell of the battery and a cell heat rejection rate of the cell of the battery.

10. The computer-implemented method of claim 1, further comprising iteratively repeating determining the anode potential current, determining the heat generation current, determining the cell voltage current, selecting the minimum current, and charging the cell of the battery of the vehicle iteratively based on a change in time.

11. A vehicle comprising:
a battery comprising a cell; and
a proportional-integral-derivative-based controller comprising:
a memory comprising computer readable instructions; and
a processing device for executing the computer readable instructions, the computer readable instructions controlling the processing device to perform operations for current (DC) fast charging for the cell of the battery of the vehicle under non-uniform temperature distribution, the operations comprising:
determining an anode potential current to apply during the DC fast charging;
determining a heat generation current to apply during the DC fast charging:
determining a cell voltage current to apply during the DC fast charging;
selecting a minimum current from the anode potential current, the heat generation current, and the cell voltage current; and
charging the cell of the battery of the vehicle based on the minimum current.

12. The vehicle of claim 11, wherein the anode potential current is determined using an anode potential proportional-integral-derivative controller.

13. The vehicle of claim 11, wherein the heat generation current is determined using a heat generation proportional-integral-derivative controller.

14. The vehicle of claim 11, wherein the cell voltage current is determined using a cell voltage proportional-integral-derivative controller.

15. The vehicle of claim 11, wherein the anode potential current, the heat generation current, and the cell voltage current are based at least in part on a lithium battery (LiB) value for a present time t₀, a cell temperature for the present time t₀, a state of charge for the present time t₀, and a current for the present time t₀.

16. The vehicle of claim 11, wherein the operations further comprise performing a simulation of fast charging the cell of the battery of the vehicle using the minimum current.

17. The vehicle of claim 16, wherein the operations further comprise charging the cell of the battery of the vehicle based on results of performing the simulation of fast charging the cell of the battery of the vehicle using the minimum current.

18. The vehicle of claim 16, wherein the simulation of fast charging the cell of the battery of the vehicle comprises projecting cell response to the minimum current for a forward-looking period of time.

19. The vehicle of claim 11, wherein determining the heat generation current is based on a cell heat generation rate for the cell of the battery and a cell heat rejection rate of the cell of the battery.

20. A computer program product comprising a computer readable storage medium having program instructions embodied therewith, the program instructions executable by at least one processor to cause the at least one processor to perform operations for direct current (DC) fast charging for a cell of a battery of a vehicle under non-uniform temperature distribution, the operations comprising:
determining an anode potential current to apply during the DC fast charging;
determining a heat generation current to apply during the DC fast charging;
determining a cell voltage current to apply during the DC fast charging;
selecting a minimum current from the anode potential current, the heat generation current, and the cell voltage current; and
charging the cell of the battery of the vehicle based on the minimum current.
